(19) United States
(12) Patent Application Publication
(10) Pub. No.: US 2020/0320651 A1
(43) Pub. Date: Oct. 8, 2020

(54) TUTORING DATA PROCESSING SYSTEM, METHOD AND COMPUTER PROGRAM PRODUCT

(71) Applicant: TEDU, LLC, Miami, FL (US)

(72) Inventor: James Nicolo Bates, Miami, FL (US)

(21) Appl. No.: 16/374,612

(22) Filed: Apr. 3, 2019

(51) Int. Cl. G06Q 50/20; G06Q 10/10

(52) U.S. Cl. CPC G06Q 50/205; G06Q 10/1095

(57) ABSTRACT

A tutor matching method includes receiving a request identifying a student and specifying a topic for a duration at a time. A record is located for the student that stores a course listing of courses for the student, a demographic profile and an indication of a number of credits available for use by the particular student in procuring tutoring. A database of registered tutors is then queried for particular tutors able to provide tutoring in connection with the topic and in response, a subset of the tutors able to provide the tutoring for the topic for the duration at the time are received. Finally, a message is broadcast to each tutor in the subset prompting an acceptance of an assignment of tutoring for the student by one or more of the tutors in the subset, and responsive to a first accepting one of the tutors in the subset, a meeting is scheduled between the particular student and the first accepting one of the tutors at a determined location for the specified time.

### BACKGROUND OF THE INVENTION

### Field of the Invention

The present invention relates to the field of on-line scheduling and more particularly to the coordination of a student tutoring session.

### Description of the Related Art

The process of classroom education refers to the attendance by a student in a class instructed by a teacher within a classroom environment at an educational institution. Traditional classroom education involves the delivery of one or more classroom lectures, roundtable discussions or laboratories on a fixed schedule according to a syllabus with one or more graded examinations administered throughout. In so far as the material instructed during a classroom session may be of such density so as to required additional instruction, in many instances, additional private sessions with the instructor may be attended by a student in the form of “office hours”. As well, to the extent that the office hours are not sufficient to service the instructional needs of all students, for many courses, teaching assistants are enlisted to provide additional instruction also in the form of office hours, or alternatively in a group attended additionally scheduled class.

Despite opportunities afforded by classroom instruction and office hours in the academic session, oftentimes, for many students, more personalized attention is required. To that end, in most academic environments, private and small-group tutoring services may be offered, either as an offering of the academic institution, an offering that is separate from but coordinated by the academic institution, or as a third party offering without coordination with the academic institution. In the former instance, the academic institution may allocate space in the physical plant of the campus and hire or contract one or more tutors to be present during certain defined hours within the physical plant. In the latter circumstance, individual, enterprising students may advertise available tutoring services through campus media, printed flyers, online advertising, or by word of mouth. Notwithstanding, the manner in which tutoring services are offered, whether by the academic institution or privately by a third party, is not without its drawbacks.

In this regard, as an initial matter, the need for a tutor oftentimes arises suddenly and, in many instances, in reference to an impending examination. Yet the rigid hours of a university tutoring center may not accommodate the urgent and timely needs of such students. As well, for private, third party tutors, rapidly identifying a particular tutor with specific expertise in the chosen area of study can be problematic and many private tutors lack flexible scheduling that would permit last minute tutoring sessions. Of course, whereas the university tutoring center has some ability to pre-screen tutors prior to permitting the tutors to tutor students, there is no such screening process for private tutors. Thus, the student in need of tutoring must simply trust the assertions of a private tutor that the private tutor is able to provide effective tutoring in the subject of interest. Finally, the tutoring needs of different students in respect to a same subject may vary depending upon the abilities and knowledge and learning style of each of the different students. Yet, in both the context of the university sponsored or supported tutoring center, and also in context of third party private tutoring, the matching of tutors to students in need is largely driven by the non-strategic, random assignment of available tutors.

### BRIEF SUMMARY OF THE INVENTION

Embodiments of the present invention address deficiencies of the art in respect to scheduling of tutoring for students in an academic environment and provide a novel and non-obvious method, system and computer program product for tutoring. In an embodiment of the invention, a tutor matching includes receiving a request for tutoring in memory of a host computing system from over a computer communications network, the request identifying a particular student registered for academic studies at an academic institution and in respect to a specific academic topic for a specified duration at a specified time. The method further includes locating a student record for the identified particular student, the student record storing data specifying a course listing of courses for which the particular student is registered at the academic institution, a demographic profile of the particular student and an indication of a number of credits available for use by the particular student in procuring tutoring services.

The method yet further includes querying a database of tutors registered with the host computing system to provide tutoring services in connection with the specific academic topic and receiving in response to the querying, a subset of the tutors that are able to provide the tutoring services in connection with the specific academic topic for the specified duration at the specified time. Finally, the method includes transmitting a broadcast message to each of the tutors in the subset prompting each of the tutors to accept an assignment of tutoring for the particular student, selecting a first accepting one of the tutors in the subset to provide tutoring services to the particular student and responding to the selection by the first accepting one of the tutors in the subset by scheduling a meeting between the particular student and the first accepting one of the tutors at a determined location for the specified time, and transmitting a message to each of the particular student and the first accepting one of the tutors indicating the scheduled meeting at the determined location for the specified time.

In one aspect of the embodiment, the method additionally includes computing an intensity of tutoring required by the particular student based upon the duration of tutoring specified in the request and selecting a later accepting one of the tutors associated with data in the host computing system having a profile matching the computed intensity better than the first accepting one of the tutors. For instance, the intensity is computed based upon a disparity between the duration of the request and an amount of time historically associated with tutoring for the specified academic topic. As another example, the intensity is computed based upon a current grade for a corresponding course associated with the specified academic topic. As yet another example, the intensity is computed based upon a complexity of words used in the request. For instance, each word in the request can be matched to a corresponding word in an index mapped to a complexity score. The total of complexity scores for all words in the request can then be summed and then divided by the total number of the words to produce an average word complexity value which then can be associated with a specific intensity in a table or by formula. Alternatively, the request can be submitted to a semantic analysis engine which can return a complexity score for the words of the request.

In another aspect of the embodiment, the selection of a first accepting one of the tutors in the subset to provide tutoring services to the particular student, includes determining whether or not the particular student is registered with the host computing system as a premium user as opposed to a standard user. On the condition that it is determined that the particular student is registered with the host computing system as a premium user, a message is transmitted to the particular student with a list of one or more of the tutors in the subset recorded as having previously tutored the particular student and the particular student is prompted to select an assignment of one of the tutors in the subset to perform the tutoring services as requested by the particular student. But, otherwise a first accepting one of the tutors in the subset is selected to provide tutoring services to the particular student.

In even yet another aspect of the embodiment, the method further includes receiving in memory of the host computing platform from over the computer communications network an indication that the tutoring services have commenced between the particular student and the selected one of the tutors. In response to the indication, a timer is initiated. Thereafter, upon a lapse of the duration specified in the request from the initiated timer, a portion of the credits available for the particular student is transferred to a record established in the host computing system for the selected one of the tutors. Optionally, during the tutoring services after the tutoring services have commenced between the particular student and the selected one of the tutors, a request to pause may be received from over the computer communications network. In response, the timer may be paused. Optionally, the pause may be limited to a fixed period of time per session or fraction of a session, such as a five minutes per thirty minutes of scheduled tutoring or ten minutes per hour of scheduled tutoring. But, upon receiving a subsequent request to resume the tutoring services, the timer is resumed. Alternatively, after a pre-determined duration of time for the pause, the timer may be resumed automatically without user intervention.

Of note, at the conclusion of sixty (60) minutes of the scheduled tutoring, both the student and the selected one of the tutors are prompted to continue the session if the tutoring session has been scheduled for more than 60 minutes. In this way, in the event the tutoring session has ended, but either or both of the parties has neglected to indicate that the session has ended, the tutoring session automatically will terminate absent an express consent by both particular student and the selected one of the tutors to continue the tutoring session.

In another embodiment of the invention, a data processing system is configured for tutor matching. The system includes a host computing system that includes one or more computing servers, each with memory and at least one processor. The system also includes a multiplicity of communicative links with a corresponding multiplicity of remote computing devices over a computer communications network. The system further includes a database coupled to the host computing system. The database has a multiplicity of records, each corresponding to a different student, each including course listing of courses for which the different student is registered at an academic institution, a demographic profile of the different student and an indication of a number of credits available for use by the different student in procuring tutoring services. The database yet further includes a registry of different tutors able to provide tutoring services in connection with different academic topics.

Of import, the system includes a tutor matching module executing in memory of the host computing system. The module includes computer program instructions enabled during execution in the host computing system to perform receiving a request for tutoring from over the computer communications network, the request identifying a particular student registered for academic studies at an academic institution and in respect to a specific academic topic for a specified duration at a specified time. The instructions also perform locating a student record for the identified particular student in the database and querying the database in connection with the specific academic topic. Finally, the instructions perform receiving in response to the querying, a subset of the tutors that are able to provide the tutoring services in connection with the specific academic topic for the specified duration at the specified time, transmitting a broadcast message to each of the tutors in the subset prompting each of the tutors to accept an assignment of tutoring for the particular student, selecting a first accepting one of the tutors in the subset to provide tutoring services to the particular student, and transmitting a direct message over the computer communications network to the particular student prompting the particular student to confirm an assignment of the selected one of the tutors to perform the tutoring services as requested by the particular student.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for tutor matching;

FIG. 2 is a schematic illustration of a data processing system configured for tutor matching; and,

FIG. 3 is a flow chart illustrating a process for tutor matching.

### DETAILED DESCRIPTION OF THE INVENTION

Embodiments of the invention provide for tutor matching. In accordance with an embodiment of the invention, a student requests a tutoring session through a user interface to a mobile application communicatively coupled to a remote tutor matching server. As part of the request, the student specifies an academic topic of interest. Optionally, a course listing of courses for which the student has been contemporaneously registered may be presented in the user interface from which the student may select the academic topic of interest. As well, the student may provide additional specific information as to the nature of the requested tutoring in a free form field of the user interface. Finally, the student may provide a desired duration of time and a time during which the tutoring session is to occur. Once the request has been formulated, the request is transmitted to the remote tutor matching server.

Upon receiving a tutor matching request, the programmatic code of the tutor matching server determines a level of intensity required for the requested tutoring session. In this regard, the level of intensity may be computed according to pre-stored recommended durations for the specified topic of interest in the request as compared to the duration of time requested by the student in the request. To the extent that a disparity exists in the requested duration and the pre-stored recommended duration, an intensity is determined as a function of the disparity, for instance as a proportionate value or an inversely proportionate value. The level of intensity also may be computed based upon an analysis of the words in the free form text provided with the request with different ones of the words mapping to different values of sophistication such that a total score of values indicates a degree of sophistication of the student requesting tutoring and a correspondent required intensity of tutoring. As even yet another alternative, the intensity of tutoring may be computed as a function of a current grade or set of examination scores in the contemporaneously registered course pertaining to the requested academic topic of interest, or any combination thereof.

Once the level of intensity has been determined, a registry of registered tutors is queried to locate a tutor having a pre-stored profile that includes an ability to provide tutoring at the requisite level of determined intensity for the specified academic topic at the designated time for the specified duration. In response to the query, the registry returns one or more prospective tutors and the tutor matching system broadcasts over the computer communications network a message to each of the prospective tutors indicating the requested tutoring session. In a first aspect of the embodiment, a first responding one of the prospective tutors to the message is selected as the tutor for the student in response to the tutoring request. Importantly, the first responding tutor amongst the prospective tutors is selected without further input by the student so as to avoid the practice by the student of preferring a particular one of the tutors based upon criteria not already considered by the tutor matching system in matching the request to the pre-stored profiles of the tutors and the requisite level of intensity required to those determined to be prospective tutors.

However, in a second aspect of the embodiment, a membership level of the student of standard results in the assignment of the first matching tutor to the requested tutoring session, but a membership level of the student of premium results in a list of one or more of the prospective tutors responding to the message, having been recorded as having previously tutored the particular student, from which the student may select one of the tutors. In either circumstance, ultimately a tutoring session is scheduled as between the selected tutor and the student at the designated time at a determined location and messages are sent to both the selected tutor and the student and the tutor and student are then presumed to meet for the tutoring session at the determined location and the designated time.

Upon the commencement of the tutoring session at the determined location at the designated time, the assigned tutor, the student or both may indicate as much by indicating a request to start the session through respective user interfaces within respective mobile devices. Responsive to the indication of the commencement of the tutoring session, a timer set at the duration for the tutoring session initiates. Optionally, the timer may be paused responsive to a request to pause the tutoring session presented through the user interface of either or both of the student and the assigned tutor. At the conclusion of the tutoring session denoted by the expiration of the timer, a pre-determined number of credits associated with the student are deducted from an account of the student as indicated in a database of the tutor matching service, and credited to the account of the assigned tutor, also as indicated in the database of the tutor matching service.

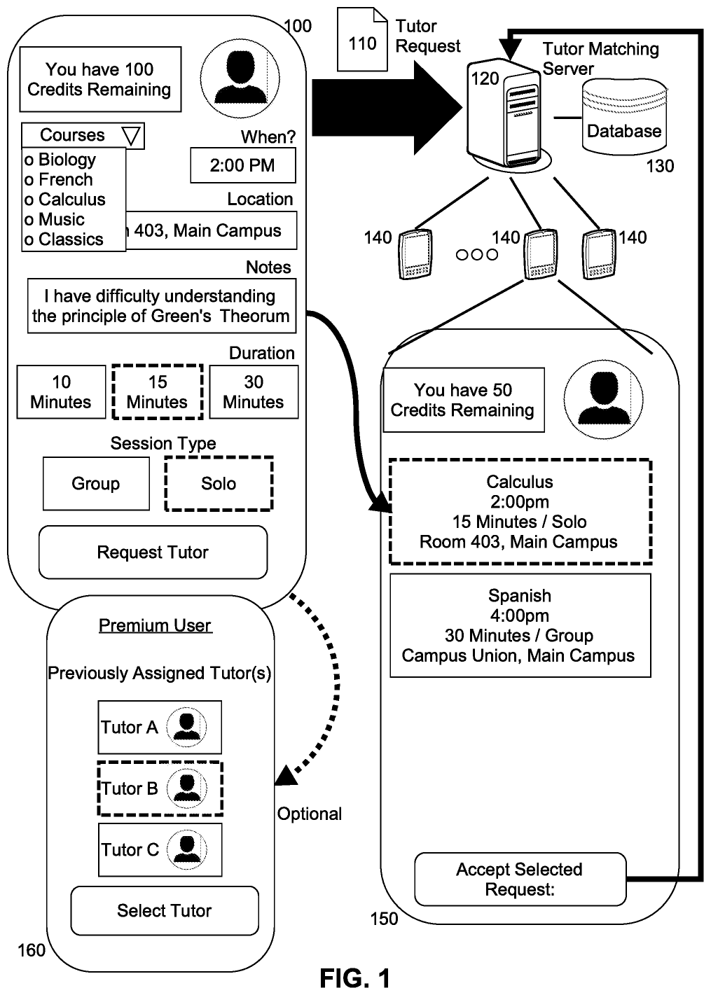

In further illustration, FIG. 1 pictorial shows a process for tutor matching. As shown in FIG. 1, a student through user interface 100 to a tutor matching server 120 formulates a request for tutoring services. The request is formulated through the interaction by the student with different user interface controls of the user interface 100. In particular, and as a non-limiting example, FIG. 1 shows a user interface 100 including controls presenting a selectable list of courses for which the student has been contemporaneously registered and for which tutoring is requested, an input field into which a time for the tutoring session may be specified, an input field into which a location for the tutoring session may be specified, a free-form text input field into which additional comments regarding the required tutoring services may be provided, a selection of tutoring session durations, a selection of tutoring session types, and a submit button responsive to which a tutor request 110 including the information provided in the user interface 100 is transmitted over a computer communications network to the tutor matching server 120.

The tutor matching server 120, upon receiving the tutor request 110 computes a required intensity of tutoring for the tutor request 110. In this regard, the tutor matching server 120 computes the required intensity based upon a comparison of the duration of tutoring requested in the tutor request with data stored in database 130 indicating a customary or typical duration of tutoring provided for the selected course in the tutor request, or a historical duration of tutoring provided to the student during a previous tutoring session for the selected course. Consequently, where the duration of tutoring falls short of the typical duration, or the historical duration, a higher intensity of tutoring is determined whereas where the duration of tutoring exceeds the typical duration or historical duration, a lower intensity of tutoring is determined.

As well, the required intensity may be determined by parsing the text of the free-form text input field and scoring the use of different words with more complex words receiving a higher score than less complex words. A total score may be computed and if the total score exceeds a threshold value, an advanced proficiency is determined requiring less intensive tutoring, whereas if the total score falls below the threshold value, a more limited proficiency is determined requiring more intensive tutoring.

As yet an additional possibility, a current performance in the selected course for the student is retrieved from the database 130 in which individual test scores and contemporaneous grade values for a contemporaneous set of registered courses of the student are stored, so that a high performance on past examinations indicates a sufficient proficiency and therefore a lower intensity of tutoring, whereas a low performance on past examinations indicates an insufficient proficiency and therefore a higher intensity of tutoring. Of course, other modalities of computing the requisite intensity of tutoring remain within the scope of the present invention and the foregoing are to be considered merely examples for computing an intensity of tutoring which may stand alone or together in different combinations.

Once the requisite intensity of tutoring has been computed, the tutor matching server 120 generates a request for tutoring for broadcasting to the mobile computing devices 140 of only those tutors registered in the database 130 known to have a proficiency in tutoring students in the topic specified by the tutor request 110 at the computed intensity. Each of the selected tutors receiving the broadcast request viewed the content of the broadcast request in a corresponding user interface 150. The user interface 150 of each corresponding one of the recipient tutors provides a listing of all tutoring requests broadcast to the corresponding one of the recipient tutors that has yet to be assigned to a particular one of the recipient tutors. Each entry in the listing is selectable and provides the pertinent details of the tutoring request such as the subject matter for which tutoring session is required, a time of occurrence of the tutoring session, a duration of the tutoring session, and a location for the tutoring session. As well, the user interface 150 permits filtering of the entries in the listing according to subject matter, time of occurrence, duration, location, whether or not the request is for individual tutoring, or whether or not the request is for a group tutoring session. The user interface 150 additionally includes an activatable submit button submitting the election by the corresponding one of the tutors to perform the requested tutoring services for the selected request in the listing.

The tutor matching server 120 generally assigns a tutor to the student on a first-come first-serve basis meaning the first of the tutors accepting the broadcast request automatically is assigned to the student for tutoring. However, in an alternative aspect of the embodiment, each student may be classified as a standard subscriber to the tutor matching server 120, or a premium subscriber to the tutor matching server 120. In the former instance, the student receives an assignment of a tutor on a first-come first-serve basis as described without any opportunity by the student to select a preferred tutor beyond that selected on the basis of first-come first serve from amongst the subset of tutors determined to best match the request. But, in the latter circumstance, an additional user interface 160 is presented to the student permitting the student to select amongst a one or more of the responding tutors recorded as having previously tutored the student. To that end, a set of one or more of the responding tutors recorded as having previously tutored the student may be presented in a selectable list with each entry permitting a display of a profile of a corresponding tutor for the entry. Once the student has selected one of the entries in the list, the selected one of the tutors is then assigned to perform the tutoring services for the student.

Optionally, the student may opt for a group tutoring session through the user interface 100 as shown in FIG. 1. Responsive to the selection of the group tutoring session, a hyperlink may be generated providing a programmatic link to the assigned tutoring session. The student may then message the hyperlink to one or more other students registered in connection with the tutor matching server 120. Upon activating the hyperlink in different instance of the user interface 100 by a different student receiving the message, the assigned tutoring session is then displayed in the instance of the user interface 100 of the different student and the different student may then accept participation in the group tutoring session. For each of the different students electing to participate in the group tutoring session, the pre-determined number of credits to be transferred to the tutor for the group tutoring session increases by a marginal amount, but the proportion of the number of credits transferred from each individual one of the students to the tutor decreases according to a pro rata share of the number of credits based upon the number of students agreeing to participate in the group tutoring session.

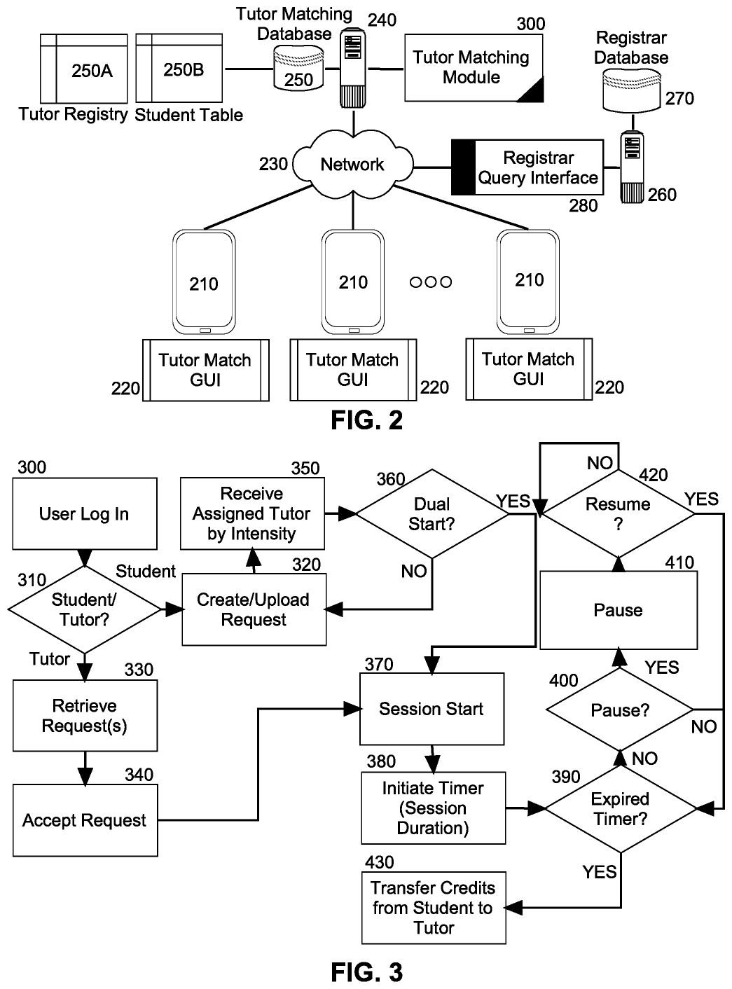

Of note, the process described in connection with FIG. 1 is implemented in a computer data processing system. In further illustration, FIG. 2 schematically shows a data processing system configured for tutor matching. The system includes a host computing server 240 including one or more computers, each with memory and at least one processor. The host computing server 240 is communicatively linked to different computing devices 210, for instance one or more mobile devices or one or more devices adapted to support the operation of a Web browser, over computer communications network 230, each of the mobile devices 210 belonging either to a student in an academic institution, a tutor at the academic institution, or both.

The host computing server 240 includes a database 250 that may include one or more databases either locally present within the host computing server 240, or accessible remotely by the host computing server 240. The database 250 includes a tutor registry 250A and a student table 250B. The tutor registry 250A includes a listing of different tutors registered to perform tutoring services in connection with one or more academic topics at a specified intensity level. The student table 250B includes a listing of different students registered to receive tutoring services. Optionally, the student table 250B includes for each corresponding student, a set of courses for which the corresponding student is contemporaneously registered at the academic institution.

The set of courses may be manually specified by the student, computationally extracted from a scanned transcript or registration document, or automatically retrieved from the registrar database 270 of the information system 260 of the academic institution by way of a query interface 280 to the registrar database 270. As an additional option, the student table 250B includes performance data for each corresponding student in respect to each corresponding course. Finally, the student table 250B includes an accounting of a number of credits owned by each corresponding one of the students for use in paying the registered tutors for tutoring services.

Importantly, a tutor matching module 300 executes in the memory of the host computing server 240. The tutor matching module 300 includes computer program instructions that during execution, receive through a tutor matching user interface 220 in a mobile device 210 of a tutor request for tutoring services in a specified academic topic of interest at a particular time and location for a specified duration of time, and compute from the tutor request, a requisite intensity of tutoring. The program instructions during execution additionally locate within the tutor registry 250A, a selection of tutors able to perform the requested tutoring services at the computed requisite intensity of tutoring. The program instructions during execution even further broadcast to the selection of tutors, the tutor request for viewing in the user interface 220 of respective ones of the mobile devices 210 of the selection of tutors. Finally, the program instructions during execution match a first responding one of the tutors to the student issuing the request and upon completion of the tutoring session, transfer credits from the student to the tutor in accordance with a quoted rate for employing the assigned tutor for the tutoring session.

In even further illustration of the operation of the tutor matching module 300, FIG. 3 is a flow chart illustrating a process for tutor matching. Beginning in block 300, an end user logs into the tutor matching system by submitting from a user interface to the tutor matching system relevant credentials that may either be processed locally in a mobile computing device of the end user displaying the user interface, or remotely in the host computing system. Subsequent to authentication, in block 310 it is determined whether the end user is acting as a student or tutor. If a student, in block 320, a tutor request is created by the student in the user interface and uploaded to the tutor matching module which computes the requisite intensity of tutoring required by the student, selects a subset of tutors registered with the tutor matching module and broadcasts a request for tutoring to each tutor in the subset. As such, in block 330, in the user interface of the mobile device of the tutor, the request for tutoring is received and in block 340, the tutor accepts the request causing an acceptance message to return to the host matching module.

In block 350, upon receiving the acceptance message, the host matching module transmits a message for display in the user interface of the mobile device of the student (and also for display in the user interface of the tutor) of a scheduled tutoring session at a determined location for the specified time. In decision block 360, on the presumption that the student and tutor meet at the determined location at the specified time, it is then determined whether or not both the student and the assigned tutor have indicated that the scheduled tutoring session has commenced and if so, the host matching module records the commencement of the tutoring session in block 370. As well, responsive to the indication that the tutoring session has commenced, in block 380 a timer is initiated for the specified duration of the tutoring session either within either or both mobile devices of the student and tutor, or in the tutor matching module.

In decision block 390, then, it is determined whether or not the timer has expired. If not, in block 400 it is further determined whether or not either or both of the student and tutor has requested a pause in the tutoring session through a suitable button control in the user interface of the respective mobile devices. If so, in block 410 the timer is paused. But, in decision block 420, if a request to resume the tutoring session is determined by operation of a user interface control of the user interface of either mobile device, then the timer resumes and in block 390 once again it is determined whether or not the timer has expired. Once the timer has expired, in block 430 the credits specified for the tutoring session are transferred from the student to the tutor.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A tutor matching method comprising:
receiving a request for tutoring in memory of a host computing system from over a computer communications network, the request identifying a particular student registered for academic studies at an academic institution and in respect to a specific academic topic for a specified duration at a specified time;
locating a student record for the identified particular student, the student record storing data specifying a course listing of courses for which the particular student is registered at the academic institution, a demographic profile of the particular student and an indication of a number of credits available for use by the particular student in procuring tutoring services;
querying a database of tutors registered with the host computing system to provide tutoring services in connection with the specific academic topic and receiving in response to the querying, a subset of the tutors that are able to provide the tutoring services in connection with the specific academic topic for the specified duration at the specified time;
transmitting a broadcast message to each of the tutors in the subset prompting each of the tutors to accept an assignment of tutoring for the particular student;
selecting a first accepting one of the tutors in the subset to provide tutoring services to the particular student; and,
responsive to the selection by the first accepting one of the tutors in the subset, scheduling a meeting between the particular student and the first accepting one of the tutors at a determined location for the specified time, and transmitting a message to each of the particular student and the first accepting one of the tutors indicating the scheduled meeting at the determined location for the specified time.

2. The method of claim 1, further comprising:
computing an intensity of tutoring required by the particular student based upon the duration of tutoring specified in the request; and,
selecting a later accepting one of the tutors associated with data in the host computing system having a profile matching the computed intensity better than the first accepting one of the tutors.

3. The method of claim 2, wherein the intensity is computed based upon a disparity between the duration of the request and an amount of time historically associated with tutoring for the specified academic topic.

4. The method of claim 2, wherein the intensity is computed based upon a current grade for a corresponding course associated with the specified academic topic.

5. The method of claim 2, wherein the intensity is computed based upon a complexity of words used in the request.

6. The method of claim 1, wherein selecting of a first accepting one of the tutors in the subset to provide tutoring services to the particular student, comprises:
determining whether or not the particular student is registered with the host computing system as a premium user as opposed to a standard user; and,
on condition that it is determined that the particular student is registered with the host computing system as a premium user, transmitting a message to the particular student with a list of one or more of the tutors in the subset recorded as having previously tutored the particular student, and prompting the particular student to select an assignment of one of the tutors in the subset to perform the tutoring services as requested by the particular student, but otherwise selecting the first accepting one of the tutors in the subset to provide tutoring services to the particular student.

7. The method of claim 1, further comprising:
receiving in memory of the host computing platform from over the computer communications network an indication that the tutoring services have commenced between the particular student and the selected one of the tutors;
responding to the indication by initiating a timer; and,
upon a lapse of the duration specified in the request from the initiated timer, transferring a portion of the credits available for the particular student to a record established in the host computing system for the selected one of the tutors.

8. The method of claim 5, further comprising:
receiving in memory of the host computing platform from over the computer communications network a request to pause the tutoring services after the tutoring services have commenced between the particular student and the selected one of the tutors;
responding to the request to pause by pausing the timer; and,
upon receiving a subsequent request to resume the tutoring services, resuming the timer.

9. The method of claim 1, wherein the request further specifies a choice between a private tutoring session and a group tutoring session, the subset of tutors being filtered to include only tutors associated with group tutoring responsive to a request further specifying a choice for a group tutoring session.

10. A data processing system configured for tutor matching, the system comprising:
a host computing system comprising one or more computing servers, each with memory and at least one processor, the system comprising a multiplicity of communicative links with a corresponding multiplicity of remote computing devices over a computer communications network;
a database coupled to the host computing system, the database comprising a multiplicity of records, each corresponding to a different student, each of the records comprising a course listing of courses for which the different student is registered at an academic institution, a demographic profile of the different student and an indication of a number of credits available for use by the different student in procuring tutoring services, the database further comprising a registry of different tutors able to provide tutoring services in connection with different academic topics; and,
a tutor matching module executing in memory of the host computing system, the module comprising computer program instructions enabled during execution in the host computing system to perform:
receiving a request for tutoring from over the computer communications network, the request identifying a particular student registered for academic studies at an academic institution and in respect to a specific academic topic for a specified duration at a specified time;
locating a student record for the identified particular student in the database;
querying the database in connection with the specific academic topic; and
receiving in response to the querying, a subset of the tutors that are able to provide the tutoring services in connection with the specific academic topic for the specified duration at the specified time;
transmitting a broadcast message to each of the tutors in the subset prompting each of the tutors to accept an assignment of tutoring for the particular student;
selecting a first accepting one of the tutors in the subset to provide tutoring services to the particular student; and,
responsive to the selection by the first accepting one of the tutors in the subset, scheduling a meeting between the particular student and the first accepting one of the tutors at a determined location for the specified time, and transmitting a message over the computer communications network to each of the particular student and the first accepting one of the tutors indicating the scheduled meeting at the determined location for the specified time.

11. A computer program product for tutor matching, the computer program product including a computer readable storage medium having program instructions embodied therewith, the program instructions executable by a device to cause the device to perform a method including:
receiving a request for tutoring in memory of a host computing system from over a computer communications network, the request identifying a particular student registered for academic studies at an academic institution and in respect to a specific academic topic for a specified duration at a specified time;
locating a student record for the identified particular student, the student record storing data specifying a course listing of courses for which the particular student is registered at the academic institution, a demographic profile of the particular student and an indication of a number of credits available for use by the particular student in procuring tutoring services;
querying a database of tutors registered with the host computing system to provide tutoring services in connection with the specific academic topic and receiving in response to the querying, a subset of the tutors that are able to provide the tutoring services in connection with the specific academic topic for the specified duration at the specified time;
transmitting a broadcast message to each of the tutors in the subset prompting each of the tutors to accept an assignment of tutoring for the particular student;
selecting a first accepting one of the tutors in the subset to provide tutoring services to the particular student; and,
transmitting a direct message to the particular student prompting the particular student to confirm an assignment of the selected one of the tutors to perform the tutoring services as requested by the particular student.

12. The computer program product of claim 11, wherein the program instructions further perform:
computing an intensity of tutoring required by the particular student based upon the duration of tutoring specified in the request; and,
selecting a later accepting one of the tutors associated with data in the host computing system having a profile matching the computed intensity better than the first accepting one of the tutors.

13. The computer program product of claim 12, wherein the intensity is computed based upon a disparity between the duration of the request and an amount of time historically associated with tutoring for the specified academic topic.

14. The computer program product of claim 12, wherein the intensity is computed based upon a current grade for a corresponding course associated with the specified academic topic.

15. The computer program product of claim 12, wherein the intensity is computed based upon a complexity of words used in the request.

16. The computer program product of claim 11, wherein the selecting of a first accepting one of the tutors in the subset to provide tutoring services to the particular student, comprises:
determining whether or not the particular student is registered with the host computing system as a premium user as opposed to a standard user; and,
on condition that it is determined that the particular student is registered with the host computing system as a premium user, transmitting a message to the particular student with a list of one or more of the tutors in the subset recorded as having previously tutored the particular student and prompting the particular student to select an assignment of one of the tutors in the subset to perform the tutoring services as requested by the particular student, but otherwise selecting the first accepting one of the tutors in the subset to provide tutoring services to the particular student.

17. The computer program product of claim 11, wherein the program instructions further perform:
receiving in memory of the host computing platform from over the computer communications network an indication that the tutoring services have commenced between the particular student and the selected one of the tutors;
responding to the indication by initiating a timer; and,
upon a lapse of the duration specified in the request from the initiated timer, transferring a portion of the credits available for the particular student to a record established in the host computing system for the selected one of the tutors.

18. The computer program product of claim 15, wherein the program instructions further perform:
receiving in memory of the host computing platform from over the computer communications network a request to pause the tutoring services after the tutoring services have commenced between the particular student and the selected one of the tutors;
responding to the request to pause by pausing the timer; and,
upon receiving a subsequent request to resume the tutoring services, resuming the timer.

19. The computer program product of claim 11, wherein the request further specifies a choice between a private tutoring session and a group tutoring session, the subset of tutors being filtered to include only tutors associated with group tutoring responsive to a request further specifying a choice for a group tutoring session.
